(19) United States
(12) Patent Application Publication
(10) Pub. No.: US 2008/0282509 A1
(43) Pub. Date: Nov. 20, 2008

(54) Self gauging clamp

(75) Inventor: Robert F. Fay, York, PA (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: Murray Corporation, Hunt Valley, MD (US)

(21) Appl. No.: 12/152,997

(22) Filed: May 19, 2008

Related U.S. Application Data
(60) Provisional application No. 60/930,570, filed on May 17, 2007.

(51) Int. Cl. F16L 33/02; G09F 3/00

(52) U.S. Cl. 24/19; 24/16 R; 40/299.01

(57) ABSTRACT

A hose clamp is provided that contains a built in gage feature to provide visual indication to the installer that the clamp is properly tensioned (crimped) by the installer. The clamp does away with the detrimental effects of a long tongue and over-band, and makes use of the tongue exiting through the band as a visual aid for correct installation. The clamp of the present invention eliminates the need for a separate gage to verify installation.

### CROSS REFERENCE TO RELATED APPLICATION

This application is based upon and claims benefit of copending and co-owned U.S. Provisional Patent Application Ser. No. 60/930,570 entitled “Self Gauging Clamp”, filed with the U.S. Patent and Trademark Office on May 17, 2007 by the inventor herein, the specification of which is incorporated herein by reference.

### BACKGROUND OF THE INVENTION

1. Field of the Invention

The present invention relates to a hose clamp, and more particularly to a clamp having a built in gage feature to provide visual indication that the clamp is properly tensioned in order to verify completeness of closure and indicate wear of the installation tool.

2. Background of the Prior Art

Clamps are available in a wide variety of configurations for meeting the requirements of particular applications. For example, hose clamps are commonly used for mounting hose ends on various objects, such as radiators, water pumps, heaters, etc. Plastic pipe is used in many plumbing applications and for irrigation applications.

Different types of clamps are available. U.S. Pat. No. 2,614,304, to Oetiker, discloses a clamp having outwardly-projecting, deformable ears to facilitate installation. Once the clamp is in place, the ears are squeezed together with a suitable tool such as a pair of pliers to hold the clamp in place and to prevent leakage from the hose or pipe. Clamp structures provided with so-called “Oetiker” ears have enjoyed enormous commercial success.

Other examples of clamps are found in U.S. Pat. Nos. 3,402,436; 5,070,580; 5,282,295; and 7,093,326. Typically, the clamps were directed at improving the load bearing capacity of the ear. The need for increased load was market driven by such things as use on pressurized applications (versus non-pressure or very low pressure), use on hose/tube materials that are of increased hardness (i.e. underground sprinkler/irrigation systems), and use in the home construction market for PEX plumbing applications. None of the improvements was directed to provide indication to the installer that the clamp is properly tensioned.

Current market applications are particularly challenging in that PEX tubing (per ASTM F 876-01) is very hard and rigid. PEX tubing can be used for both hot and cold water systems that may be at pressures of up to 100 psi for prolonged periods of time. Generally speaking, this market is a professional contractors market, however, it is expected that the market will expand into the home repair and do-it-yourself markets as well.

There remains a need, then, for a simple means of verifying proper clamp tensioning that does not involve the use of separate gages or extra effort by the clamp installer.

### SUMMARY OF THE INVENTION

The present invention is concerned with new style pinch-type (PEX) clamp for PEX plumbing pipe applications. The present invention enables a clamp having a built in gage feature to provide visual indication that the clamp is properly tensioned.

Throughout the history of pinch clamp usage, operators often wondered just how tight is the clamp being installed and is it tight enough for the specific application. An installed pinch clamp should provide a sufficient seal such that, pull-off resistance of the clamp is sufficiently high to cause the tube to fail mid-length while the clamped end remains attached to its fitting, without drifting from its original position. Once the clamp is put on and the installation tool is removed, the ear opens slightly due to natural spring-back of the clamp material, due to the tensile load stored in the band, and due to energy stored in the compressed tubing. The general guideline offered to the concerned public is that the “ear will spring open slightly” after installation and for general purposes a visible gap at the root of the pinched ear will be around 1/32″. The problem comes about by the fact that many operators are not capable of determining the gap size with any degree of precision and/or consistency. Additionally, over repeated installations the pivot points of existing installation tools wear, the wear being compounded by the higher forces needed for heavy duty PEX clamp. As this wear occurs gradually with time, it is not readily apparent to the operator. Eventually, worn-out tools are inadvertently used to make clamp installations resulting in large gaps that do not meet the standard of what the clamping system can tolerate. The consequence is failed connections and leaking water supply systems.

It is, therefore, an object of the present invention to provide a pinch-type clamp that avoids the disadvantages of the prior art.

It is an objective of the present invention is to do away with the subjective ear root gap size concern by providing a clamp with a built in gage feature to provide visual indication that the clamp is properly tensioned.

In accordance with the above objects, a clamp is provided that does away with the detrimental effects of a long tongue and over-band, and makes use of the tongue exiting through the band as a visual aid for correct installation. The clamp of the present invention eliminates the need for a separate gage to verify installation.

Other objects and advantages of this invention will become apparent from the following description taken in conjunction with the accompanying drawings wherein are set forth, by way of illustration and example, certain embodiments of this invention. The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows a side view of a clamp according to a first embodiment of the present invention.

FIG. 2 shows a left side view of the clamp of FIG. 1.

FIG. 3 shows a right side view of the clamp of FIG. 1.

FIG. 4 shows a bottom view of the clamp of FIG. 1.

FIG. 5 shows a top view of the clamp of FIG. 1.

FIG. 6 shows a cross section of the clamp of FIG. 5, taken along the line B-B.

FIG. 7 shows an internal cross section of the clamp of FIG. 1, taken along the line A-A.

FIG. 8 shows a side view of the clamp of FIG. 1 in the direction indicated by the arrow labeled C.

FIG. 9 shows a front and side view of a clamp according to a first embodiment of the present invention prior to installation.

FIG. 10 shows a front and side view of a clamp according to a first embodiment of the present invention after installation with a worn crimping tool.

FIG. 11 shows a front and side view of a clamp according to a first embodiment of the present invention after typical installation with a crimping tool.

FIG. 12 shows a front and side view of a clamp according to a first embodiment of the present invention after installation with a two-step crimping tool.

### DESCRIPTION OF EXEMPLARY EMBODIMENTS

The invention summarized above and defined by the enumerated claims may be better understood by referring to the following description, which should be read in conjunction with the accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The present invention enables a new style pinch clamp for PEX plumbing pipe. The clamp contains a built in gage feature to provide visual indication to the installer that the clamp is properly tensioned (crimped) by the installer. Proper tensioning is critical in plumbing applications due to the potential for water leaks, and resultant damage. The clamp, according to the present invention, does away with the detrimental effects of a long tongue and over-band, and makes use of the tongue exiting through the band as a visual aid for correct installation. Other means of verifying proper clamp tensioning typically involve the use of separate gages. The clamp of the present invention eliminates the need for a separate gage to verify installation

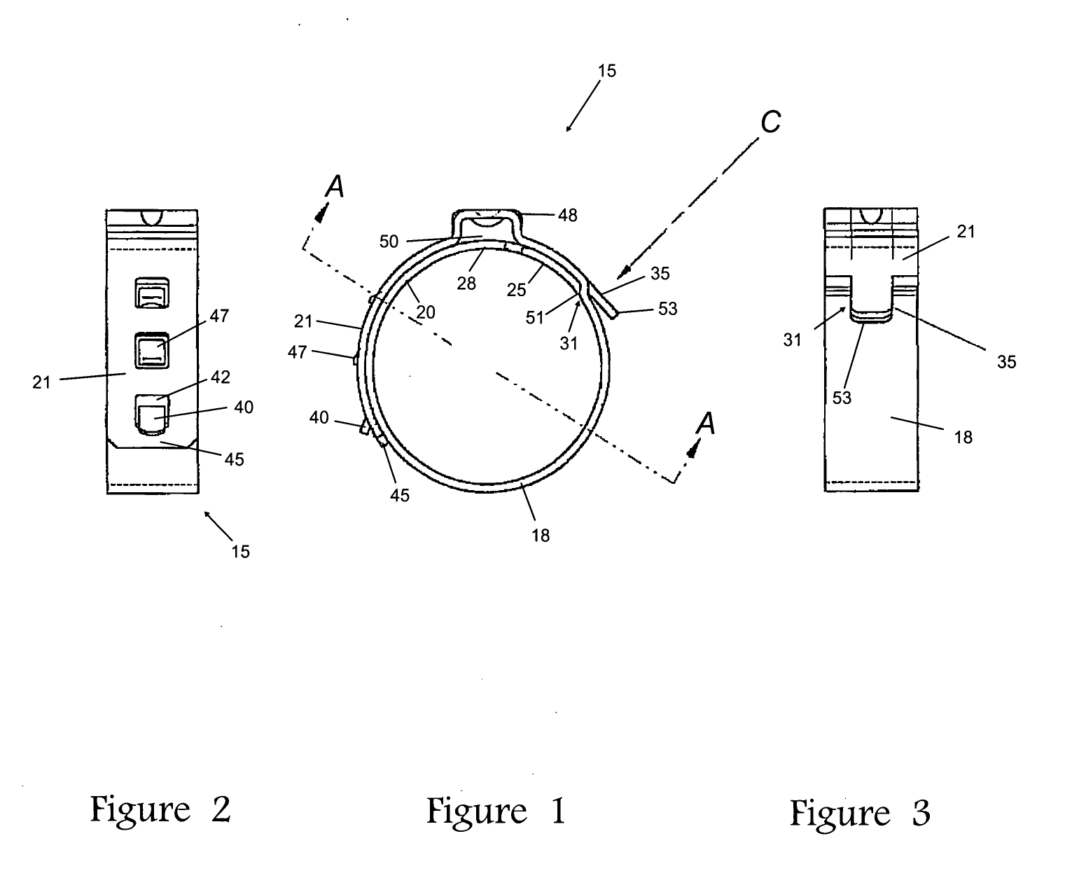

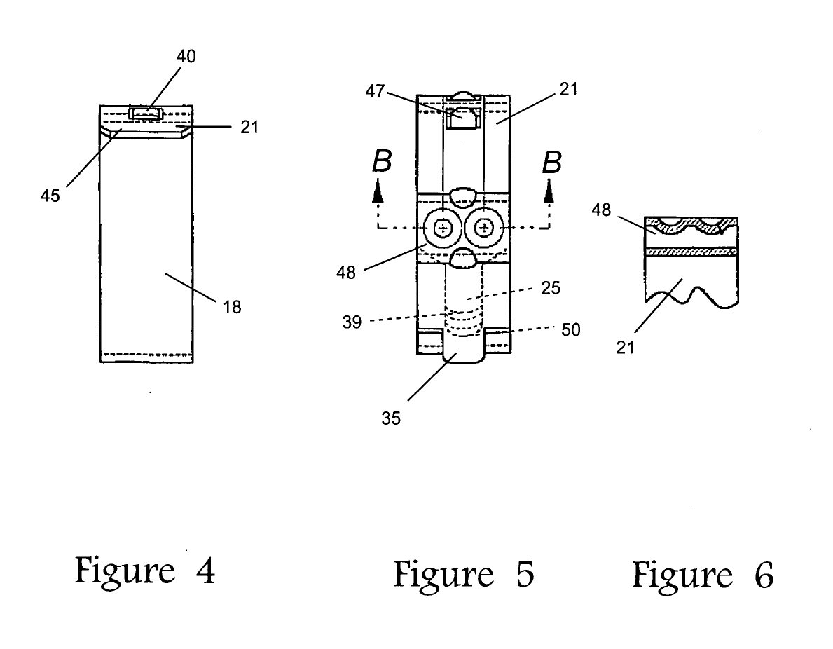

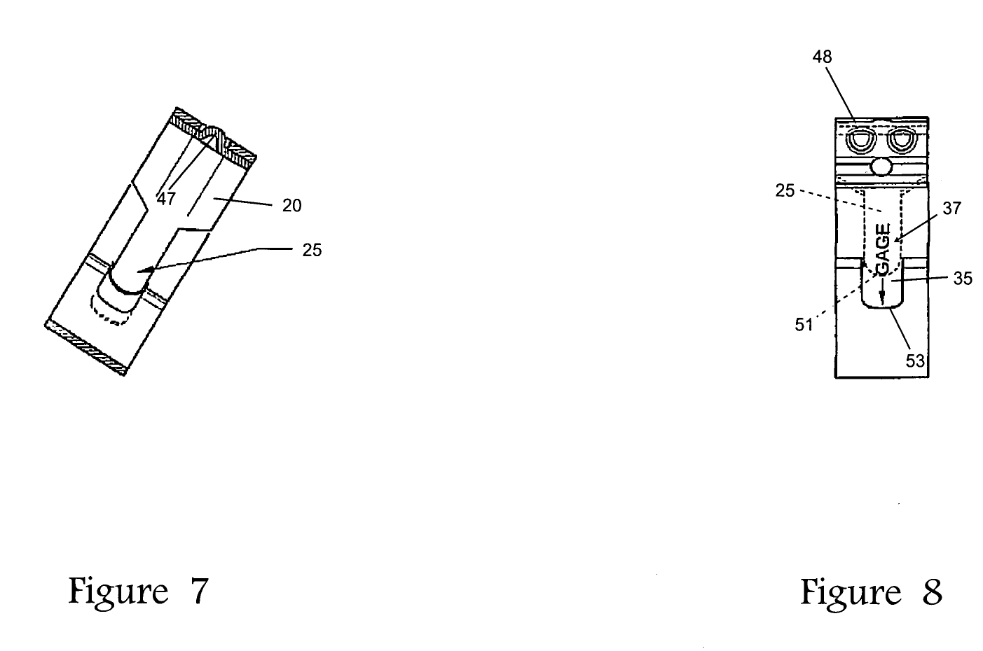

Referring to the drawings, FIGS. 1-8 show various views of a hose clamp, indicated generally as 15, according to the present invention. The clamp 15 consists of an open band 18 comprising overlapping inner and outer bands 20, 21, respectively. The clamp 15 is adapted to be transferred from a pre-installed condition in which the inner band 20 is connected to the outer band 21, as described in more detail below, having a first inner diameter to a tightened condition having a reduced inner diameter. The pre-installed diameter and tightened diameter can be selected based on the pipe size for its intended use. Preferably, the clamp 15 will be slightly out of round in the pre-installed condition to enable the clamp 15 to hang on standard PEX tubing without falling off. In a preferred embodiment, the band 18 will be made of stainless steel approximately 9 mm wide and approximately 0.78 mm thick. One skilled in the art will select an appropriate material for its strength and ability to be flexible.

The band 18 includes an inner tongue 25 integrally formed at the end 28 of the inner band 20. The inner tongue 25 is formed as a narrower portion approximately 0.35 mm wide at the end 28 of the inner band 20. An opening 31 is provided in the outer band 21 for receiving the inner tongue 25 in the tightened condition. The opening 31 may be approximately 1 mm×4 mm to allow the inner tongue 25 to pass therethrough. An outer tongue 35 is provided adjacent to the opening 31 in the outer band 21. The outer tongue 35 is sized and configured to assist in determining proper installation of the clamp 15. The outer tongue 35 includes a gage 37 (FIG. 8) that provides a visual indication of the extent of protrusion of the inner tongue 25 in the tightened condition. The gage 37 may be engraved in the outer tongue 35 or may be stenciled on the outer tongue 35 to indicate proper closure of the clamp 15. Other means of indication may be used. For example, an appropriate visual indication may resemble “GAGE →”. Other indicators or markings may be used. In some embodiments, the inner tongue 25 may also include lines or other markings 39 (FIG. 5) to assist in the indication of proper closure of the clamp 15.

In the assembled but not tightened condition of the clamp 15, at least one hook 40 is provided on the inner band 20, which is inserted in an aperture 42 near the end 45 of the outer band 21. In addition, one or more tabs 47 may be pressed out of the inner band to engage in other apertures 42. For tightening the clamp 15, a so-called “Oetiker ear” 48 is provided in the outer band 21. The ear 48 is narrowed by means of a pair of grippers. The inner tongue 25 in conjunction with the inner band 20 serves to bridge the gap 50 remaining underneath the ear 48.

In the pre-installed but not tightened condition of the clamp 15, the inner tongue and the tongue opening 31 are so arranged and dimensioned in the circumferential direction of the clamp 15 in such a way that, in this condition, the free end 51 of the inner tongue 25 just reaches the opening 31. Prior to tightening of the clamp 15, the distance between the free end 51 of the inner tongue 25 and the free end 53 of the outer tongue 35 may be approximately 3 mm for a ¾-inch clamp. One skilled in the art will select an appropriate length based on the size of the clamp and its intended application.

In tightening the clamp 15, the inner tongue 25 moves into the opening 31 until the crimping force is removed. The end 51 of the inner tongue 25 and/or the markings 39 (if included) can then be visually checked against the gage 37 on the outer tongue 35 to verify completeness of the installation.

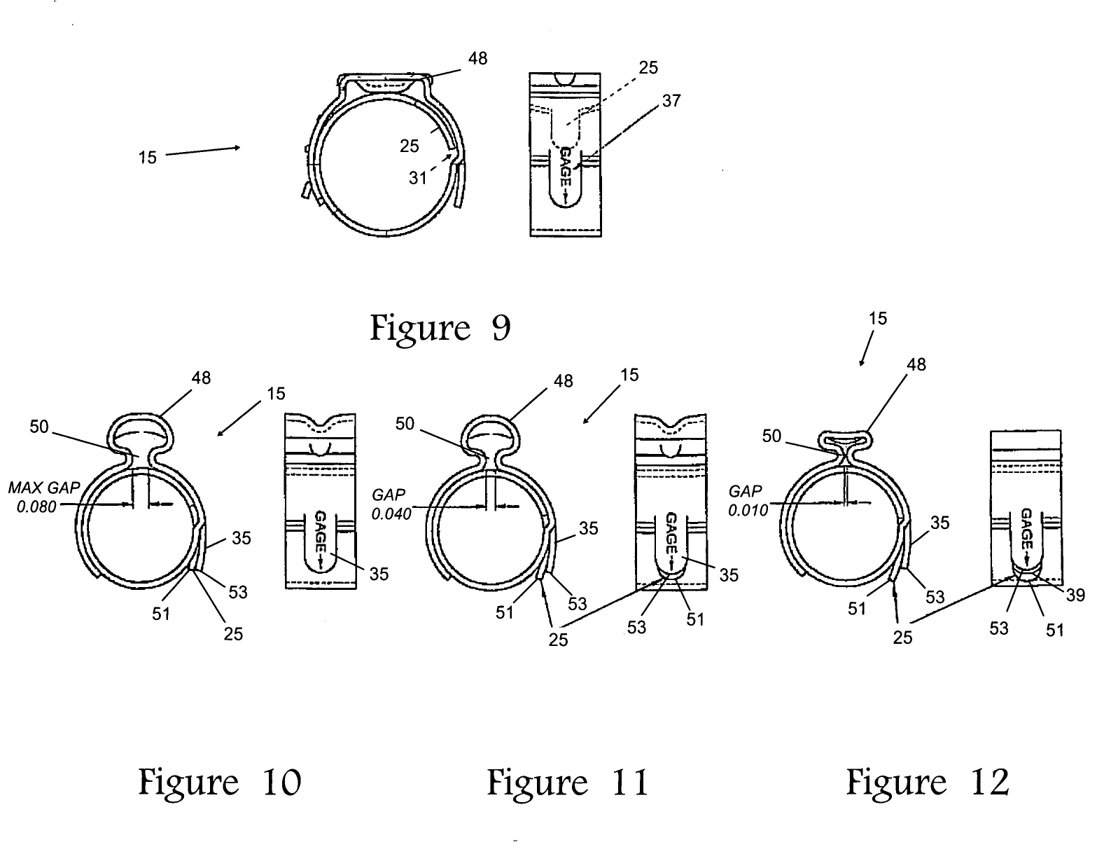

FIG. 9 shows a front and side view of a clamp 15 according to the present invention prior to installation. The inner tongue 25 is sized and configured to fit in the opening 31 and provide a visual indication when the clamp 15 is properly tensioned. FIG. 10 shows a front and side view of a clamp 15 according to the present invention after installation with a worn crimping tool. The end 51 of the inner tongue 25 is flush with the end 53 of the outer tongue 35, indicating that the clamp 15 is installed with the maximum allowable gap 50 at the root of the pinched ear 48. FIG. 11 shows a front and side view of a clamp 15 according to the present invention after installation with a standard crimping tool. The end 51 of the inner tongue 25 extends slightly beyond the end 53 of the outer tongue 35, indicating that the clamp 15 is installed with a sufficient allowable gap 50 at the root of the pinched ear 48. FIG. 12 shows a front and side view of a clamp 15 according to the present invention after installation with a two-step crimping tool. The end 51 of the inner tongue 25 extends to the maximum point beyond the end 53 of the outer tongue 35, indicating that the clamp 15 is installed with the minimum obtainable gap 50 at the root of the pinched ear 48. As shown in FIG. 12, if additional markings 39 are included on the inner tongue 25, they would be visible protruding beyond the end 53 of the outer tongue 35.

The invention has been described with references to exemplary embodiments. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It should be understood, therefore, that the invention may be practiced otherwise than as specifically set forth herein. Consequently, the present embodiments are to be considered in all respects as illustrative and not restrictive.

What is claimed is:

1. A clamp, comprising:
an overlapping clamping band having an inner band portion and an outer band portion, wherein
the inner band portion comprises an inner tongue at an end thereof; and
the outer band portion comprises
an opening for receiving said inner tongue; and
an outer tongue adjacent said opening, said outer tongue having a marking thereon providing visual indication of closure of said clamp.

2. The clamp of claim 1, further comprising tightening means.

3. The clamp of claim 2, wherein said tightening means comprises ear-type tightening means.

4. The clamp of claim 1, wherein said clamp is adapted to be transferred from an initial condition having an inner dimension to a tightened condition in which the clamp has a reduced inner dimension.

5. The clamp of claim 1, wherein said opening in said outer band enables said inner tongue to pass therethrough in a tightened condition.

6. The clamp of claim 1, wherein an end of said inner tongue extends beyond an end of said outer tongue, in a tightened condition.

7. The clamp of claim 1, said inner tongue further comprising markings to assist in indication of proper closure of the clamp.

8. The clamp of claim 7, said markings on said inner tongue comprising a stencil.

9. The clamp of claim 7, said markings on said inner tongue comprising an engraving.

10. The clamp of claim 1, said markings on said outer tongue comprising a stencil.

11. The clamp of claim 1, said markings on said outer tongue comprising an engraving.

12. The clamp of claim 1, further comprising:
at least one aperture near an end of the outer band; and
at least one hook element extending outwardly from said inner band, said hook element being operable to engage in the at least one aperture in the outer band.

13. The clamp of claim 1, further comprising:
at least one aperture near an end of the outer band; and
at least one tab extending outwardly from said inner band, said tab being operable to engage in the at least one aperture in the outer band.
